(19) United States
(12) Patent Application Publication
(10) Pub. No.: US 2013/0093966 A1
(43) Pub. Date: Apr. 18, 2013

(54) LIGHTING DEVICE, DISPLAY DEVICE AND TELEVISION DEVICE

(71) Applicant: Tatsuro Kuroda, Osaka-shi (JP)

(72) Inventor: Tatsuro Kuroda, Osaka-shi (JP)

(73) Assignee: SHARP KABUSHIKI KAISHA, Osaka-shi, Osaka (JP)

(21) Appl. No.: 13/805,026

(22) PCT Filed: May 24, 2011
(86) PCT No.: PCT/JP2011/061852

§ 371 Date: Dec. 18, 2012

(30) Foreign Application Priority Data
Jun. 25, 2010 (JP) 2010-145136

(51) Int. Cl. F21S 2/00; G02F 1/1335; G09F 13/04

(52) U.S. Cl. CPC F21S 2/00; G09F 13/04; G02F 1/133602
USPC 348/790; 362/97.1; 362/97.2; 362/217.1; 362/217.11

(57) ABSTRACT

A lighting device includes a cold cathode fluorescent tube (CCFT), a chassis housing the CCFT, and a retainer holding the CCFT such that the CCFT is allowed to be displaced with respect to a bottom plate of the chassis in a direction perpendicular to an axis of the CCFT. According to the lighting device, the CCFT can be deformed in a curved shape when an external force is applied from the chassis to the CCFT due to an error in a mounting pitch of the cold cathode fluorescent tube or thermal contraction of the chassis. This releases the external force, and thus the CCFT is less likely to be broken.

### TECHNICAL FIELD

The present invention relates to a lighting device, a display device and a television device.

### BACKGROUND ART

A liquid crystal panel used for a liquid crystal display device such as a liquid crystal television does not emit light, and thus a backlight unit is required as a separate lighting device. The backlight unit is arranged on the rear side of the liquid crystal panel (a side opposite to the display surface). The backlight unit includes a chassis with an opening on the liquid crystal panel side and discharge tubes housed in the chassis. For example, Patent Document 1 discloses that the discharge tubes are fixed to the bottom plate of the chassis by retainers, which are referred to as lamp clips.

### RELATED ART DOCUMENT

### Patent Document

Patent Document 1: Japanese Unexamined Patent Publication No. 2007-180006

### Problem to be Solved by the Invention

In recent years, the discharge tube tends to be made longer and thinner to be used for a larger or thinner screen. Such a discharge tube cannot have sufficient strength against external force acting thereon. If an error occurs in amounting pitch of the discharge tubes or thermal contraction of the chassis occur, the external force in the axial direction of the discharge tube may act on the discharge tube. In such a case, the discharge tube is deformed (in a curved shape) to release the external force. However, if a lamp clip holds the discharge tube tightly, the discharge tube cannot be deformed, and thus the discharge tube cannot release the external force. As a result, the discharge tube may be damaged.

### DISCLOSURE OF THE PRESENT INVENTION

The present invention was accomplished in view of the above circumstances. It is an object of the present invention to provide a lighting device in which the discharge tube is hardly or less likely to be damaged or broken.

### Means for Solving the Problem

To solve the above problem, a lighting device according to the present invention includes a discharge tube, a chassis housing the discharge tube, and a retainer holding the discharge tube such that the discharge tube is allowed to be displaced with respect to a bottom plate of the chassis in a direction perpendicular to an axis of the discharge tube.

In the above lighting device, the discharge tube is allowed to be displaced in the direction perpendicular to the axis of the discharge tube. Accordingly, the discharge tube can be deformed in a curved shape when an external force is applied from the chassis to the discharge tube due to the error in the mounting pitch of the discharge tubes or the thermal contraction of the chassis. This releases the external force, and thus the discharge tube is less likely to be broken.

The following configurations are preferable as aspects of the present invention.

The retainer includes a gripping member gripping the discharge tube, a mounting member mounting the gripping member on the bottom plate of the chassis, and a displacement structure by which the gripping member and the mounting member are fitted with each other such that the gripping member is allowed to be displaced in the direction perpendicular to the axis of the discharge tube. With this displacement structure, the discharge tube can be displaced in the direction perpendicular to the axis of the discharge tube.

The displacement structure is a slide structure by which the mounting member and the gripping member are fitted with each other such that the gripping member is allowed to be slid in the direction perpendicular to the axis of the discharge tube.

The mounting member includes a cutout to which the gripping member is fitted such that the gripping member is allowed to be slid in the direction perpendicular to the axis of the discharge tube. The slide structure can provide a high following capability with respect to the deformation of the discharge tube, and thus a failure (for example, the gripping member is stuck and not moved) hardly occur.

The gripping member includes a gripping portion gripping the discharge tube, a column support supporting the gripping portion, and a base portion. The mounting member includes a housing portion communicated with the cutout. The column support is slidably fitted to the cutout. The housing portion houses the base portion of the gripping member.

The displacement structure is a ball joint structure by which the gripping member and the mounting member are fitted with each other at curved surfaces thereof. With this configuration, the gripping member can be displaced in any direction of 360 degree. This provides a high following capability with respect to the deformation of the discharge tube, and thus a failure hardly occurs.

The retainer includes a gripping portion gripping the discharge tube, a mounting portion mounted on the bottom plate of the chassis, and a connection wall having a plate-like shape and connecting the mounting portion and the gripping portion. The connection wall is configured to be bent and displaced in the direction perpendicular to the axis of the discharge tube. With this configuration, the retainer can be composed of one component.

The retainer includes a gripping portion gripping the discharge tube, and a mounting portion mounted on the bottom plate of the chassis. The mounting portion is allowed to be slid in the direction perpendicular to the axis of the discharge tube. The slide structure can provide a high following capability with respect to the deformation of the discharge tube, and thus a failure (for example, the gripping member is stuck and not moved) hardly occur.

The retainer includes a frame having a discharge tube insertion cutout through which the discharge tube passes, and a mounting portion mounted on the bottom plate of the chassis. The discharge tube insertion cutout has an elongated shape in the direction perpendicular to the axis of the discharge tube, whereby the discharge tube is allowed to be displaced within the discharge tube insertion cutout in the direction perpendicular to the axis of the discharge tube. With this configuration, the discharge tube can be held in the discharge tube insertion cutout and allowed to be displaced in the direction perpendicular to the axis of the discharge tube at the same time. In addition, the retainer can be composed of one component.

A display device according to the present invention may include the above-described lighting device and a liquid crystal display panel configured to provide display using light from the lighting device. The display device can be applied to a television display or a personal-computer display, for example. Particularly, it is suitable for a large screen display.

### Advantageous Effect of the Invention

According to the present invention, a lighting device in which the discharge tube is hardly or less likely to be broken can be obtained. Further, a display device and a television device each including such a lighting device can be obtained.

### BRIEF DESCRIPTION OF THE DRAWINGS

FIG. 1 is an exploded perspective view illustrating a general configuration of a television device according to a first embodiment of the present invention;

FIG. 2 is an exploded perspective view illustrating a display device included in the television device;

FIG. 3 is a cross-sectional view of the display device taken along a line A-A in FIG. 2;

FIG. 4 is a cross-sectional view illustrating a structure for holding the cold cathode fluorescent tube by a retainer;

FIG. 5 is a bottom view of the retainer;

FIG. 6 is a plan view of the retainer;

FIG. 7 is a view illustrating a state in which the gripping members have been slid in accordance with the deformation of the cold cathode fluorescent tube;

FIG. 8 is a cross-sectional view of the retainer according to the second embodiment of the present invention;

FIG. 9 is a cross-sectional view of the retainer according to the second embodiment of the present invention;

FIG. 10 is a cross-sectional view of the retainer according to the third embodiment of the present invention;

FIG. 11 is a perspective view of the retainer according to the fourth embodiment of the present invention;

FIG. 12 is a cross-sectional view illustrating amounting structure of the retainer; and

FIG. 13 is a cross-sectional view of the retainer according to the fifth embodiment of the present invention.

### BEST MODE FOR CARRYING OUT THE INVENTION

### First Embodiment

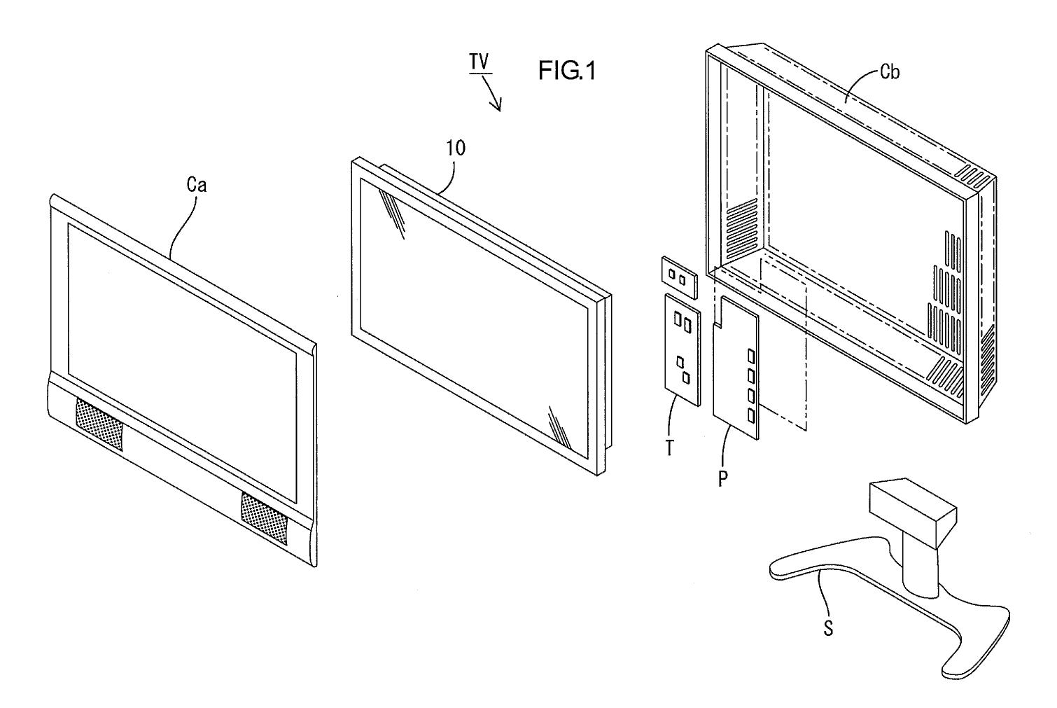

The first embodiment of the present invention will be described with reference to FIG. 1 to FIG. 7.

### 1. Description of Structure

The construction of a television device TV including a liquid crystal display device 10 will be explained.

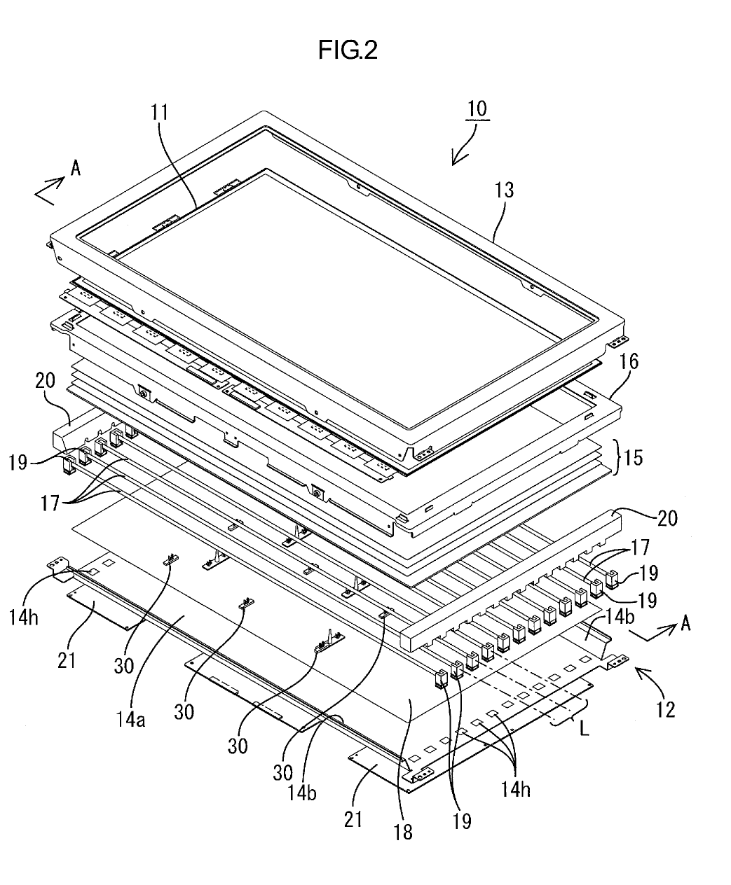

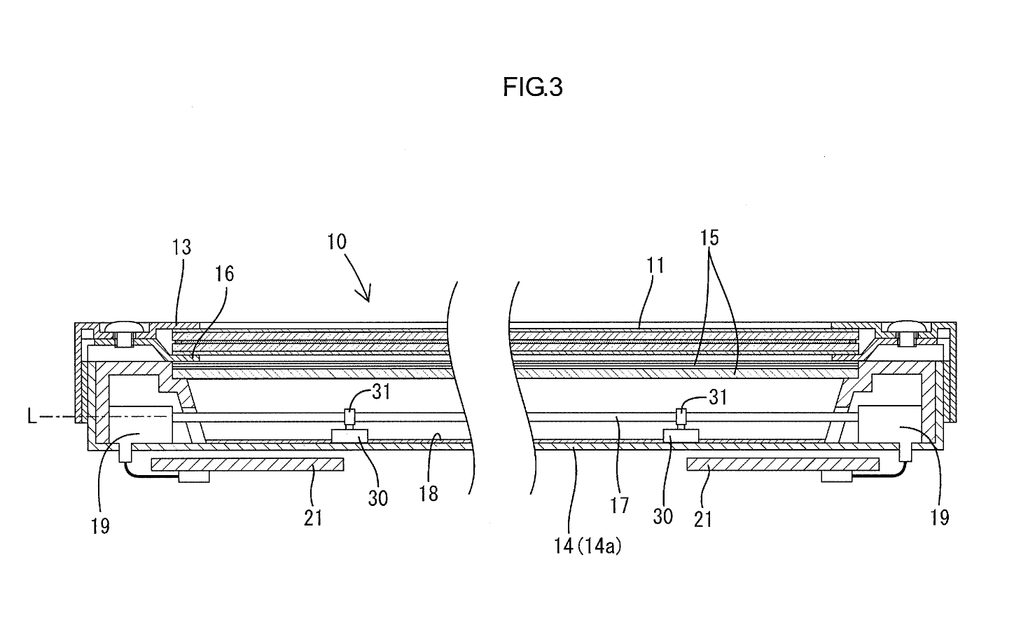

FIG. 1 is an exploded perspective view illustrating a general configuration of a television device TV according to the present embodiment. FIG. 2 is an exploded perspective view illustrating a general configuration of a liquid crystal display device 10. FIG. 3 is a cross-sectional view of the liquid crystal display device 10 taken along a line A-A in FIG. 2.

As illustrated in FIG. 1, the television device TV of the present embodiment includes the liquid crystal display device 10, front and rear cabinets Ca, Cb which house the liquid crystal display device 10 therebetween, a power source P, a tuner T, and a stand S. The liquid crystal display device (a display device) 10 has a landscape rectangular shape as a whole. The liquid crystal display device 10 is housed in a vertical position. As illustrated in FIG. 2, the liquid crystal display device 10 includes a liquid crystal panel (a display panel) 11 as a display panel, and a backlight unit (a lighting device) 12 as an external light source. The liquid crystal panel 11 and the backlight device 12 are integrally held by a frame shaped bezel 13 and the like.

Next, the liquid crystal panel 11 and the backlight unit 12 included in the liquid crystal display device 10 will be described (see FIG. 2 and FIG. 3). The liquid crystal panel 11 is configured such that a pair of glass substrates is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, and the like are provided. On the other glass substrate, counter electrodes, color filters having color sections such as red (R), green (G), and blue (B) color sections arranged in a predetermined pattern, and the like are provided.

The backlight unit 12 will be described. The backlight unit 12 is a direct-type backlight unit. The cold cathode fluorescent tubes 17 are arranged horizontally behind a rear surface of a panel surface (a display surface) of the liquid crystal panel 11.

The backlight unit 12 includes a chassis 14, an optical member 15 (a diffuser plate, a diffuser sheet, a lens sheet, and a reflection-type polarizing plate in this sequence from the lower side of FIG. 1), and a frame 16 holding the optical member 15 to the chassis 14. The chassis 14 has a box-like shape with an opening on the front side. The optical member 15 is arranged to cover the opening of the chassis 14. The chassis 14 houses cold cathode fluorescent tubes 17, retainers 30 for mounting the cold cathode fluorescent tubes 17 on the chassis 14, relay connectors 19 provided in a pair for each cold cathode fluorescent tube 17, and lamp holders 20 each collectively covering the cold cathode fluorescent tubes 17 and the relay connectors 19. The lamp holder 20 is made of a synthetic resin having a white color. As illustrated in FIG. 2, the lamp holder 20 has an elongated box-like shape extending along a short-side direction of the chassis 14. In the backlight unit 12, the side closer to the optical member 15 than the cold cathode fluorescent tube 17 is a light exiting side.

The chassis 14 is made of metal. The chassis 14 has a shallow box-like shape including a rectangular bottom plate 14a and a side walls 14b rising from respective sides of the bottom plate 14a. The chassis 14 includes through holes 14h aligned in a line at regular intervals on each end in a long-side direction thereof. The relay connectors 19 are attached to the through holes 14h. The relay connectors 19 facing each other in the long-side direction make a pair.

The cold cathode fluorescent tube 17 is a kind of discharge tube. The cold cathode fluorescent tube 17 includes a closed end elongated glass tube 17a having a circular cross-section, a pair of electrodes (not illustrated) sealed inside end portions of the glass tube 17a, and a pair of outer leads (not illustrated) protruding outwardly from the end portions of the glass tube 17a. The glass tube 17a includes mercury that is a light-emitting material inside thereof, and a fluorescent material is applied on inner surface of the glass tube 17a. The mercury and the fluorescent material are not illustrated in the drawings.

The cold cathode fluorescent tubes 17 are arranged horizontally in the chassis 14 such that an axis L of each glass tube 17a matches the long-side direction of the chassis 14. Each of the end portions of each cold cathode fluorescent tube 17 is fitted into the relay connector 19, and thus the cold cathode fluorescent tube 17 is fixed. The outer leads of the cold cathode fluorescent tube 17 are electrically connected to an inverter board 21 via the relay connector 19.

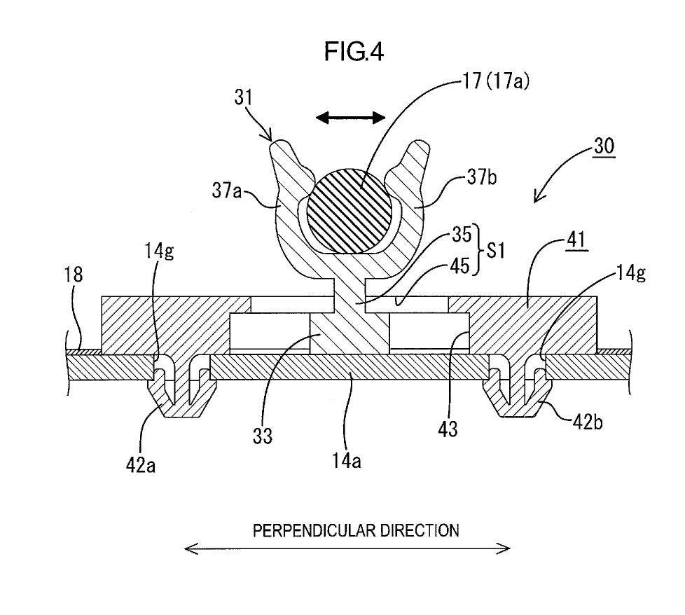

Each cold cathode fluorescent tube 17 is held by the retainers 30 at a few places (here, at three places) on a middle section in the tube axis L direction. The retainer 30 holds the cold cathode fluorescent tube 17 so as to be parallel to the bottom plate 14a of the chassis 14. In other words, the retainer 30 maintains a certain distance between the bottom plate 14a of the chassis 14 and the cold cathode fluorescent tube 17. As illustrated in FIG. 4, the retainer 30 includes a gripping member 31 gripping the cold cathode fluorescent tube 17, a mounting member 41 mounting the gripping member 31 on the bottom plate 14a of the chassis 14, and a slide mechanism S1.

The gripping member 31 is made of a synthetic resin having a white color. The gripping member 31 includes a base portion 33 and a gripping portion 37. The base portion 33 has a block-like shape. A column support 35 having a columnar shape is provided on an upper surface of the base portion 33. The gripping portion 37 is positioned on the front side of the column support 35 and includes a pair of arm portions 37a, 37b. The gripping portion 37 has an open end ring overall shape opening toward the front side and holds the cold cathode fluorescent tube 17 from each side. The gripping portion 37 has a thickness that is substantially the same as a width of a slide cutout 45, which will be described later, so that the gripping portion 37 can be fitted into the slide cutout 45.

The mounting member 41 is made of a synthetic resin having a white color. The mounting member 41 has a shape elongated in a direction substantially perpendicular to the axis L of the cold cathode fluorescent tube 17 (the horizontal direction in FIG. 4, which is referred to as a perpendicular direction). The mounting member 41 includes elastic stoppers 42a, 42b on end portions of a bottom surface thereof. The elastic stoppers 42a, 42b are fitted in stopper holes 14b formed in the chassis 14 such that the mounting member 41 is fixed to the bottom plate 14a of the chassis 14.

The mounting member 41 includes a housing portion 43 on a middle portion thereof. The housing portion 43 opens to the bottom plate side of the mounting member 41. The housing portion 43 is configured to house the base portion 33 of the gripping member 31 from the bottom surface side. The housing portion 43 has a depth substantially the same as the thickness of the base portion 33. Thus, the base portion 33 is located between the bottom plate 14a of the chassis 14 and a top of the housing portion 43. With this configuration, the base portion 33 is less likely to be inclined, and thus the gripping member 31 can be stably positioned.

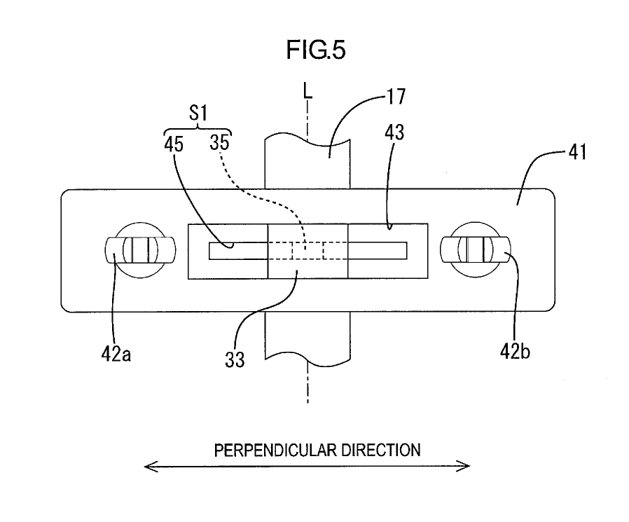

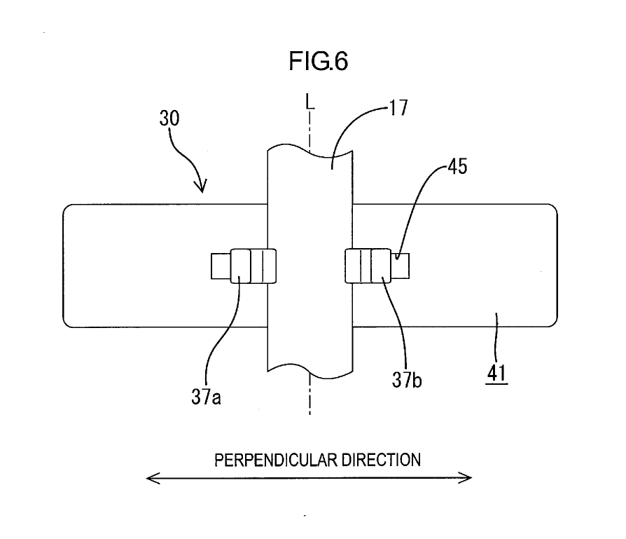

On the front side of the housing portion 43, the slide cutout 45 is provided to be communicated with the housing portion 43. The slide cutout 45 extends through an upper wall of the mounting member 42. As illustrated in FIG. 5 and FIG. 6, the slide cutout 45 has a shape elongated in the direction perpendicular to the axis L of the cold cathode fluorescent tube 17 (the horizontal direction in FIG. 5 and FIG. 6). The column support 35 of the gripping member 31 is slidably fitted into the slide cutout 45.

With the above-described configuration, the gripping member 31 can be slid in the horizontal direction in the drawings (the direction perpendicular to the tube axis L) by sliding the column support 35 along the slide cutout 45. As described above, the slide cutout 45 of the mounting member 41 and the column support 35 of the gripping member 31 provide a slide mechanism S1. The slide mechanism 51 couples the gripping member 31 with the mounting member 41 in a slidable manner in the direction perpendicular to the tube axis L.

As illustrated in FIG. 5, like the slide cutout 45, the housing portion 43 has a shape elongated in the direction perpendicular to the tube axis L (the horizontal direction in FIG. 5). In the housing portion 43, the base portion 33 housed inside the housing portion 43 can be slid in the direction perpendicular to the tube axis L (the horizontal direction in FIG. 4 and FIG. 5). In this embodiment, the base portion 33 is fitted loosely into the housing portion 43 compared with the fit between the column support 35 and the slide cutout 45. Thus, during the slide, the base portion 33 is not stuck in the housing portion 43.

The backlight unit 12 will be further explained. A light reflection sheet 18 is arranged in the chassis 14 on a side opposite to the light exit side of the cold cathode fluorescent tube 17 (on an inner surface of the bottom plate of the chassis 14) to provide a light reflection surface. The light reflection sheet 18 is made of a synthetic resin and has a white surface that provides high light reflectivity. As illustrated in FIG. 3, the light reflection sheet 18 extends along the inner surface of the chassis 14 so as to cover substantially the entire area of the chassis 14. The light reflection sheet 18 can reflect light emitted from the cold cathode fluorescent tube 17 toward the optical member 15.

Further, the inverter board (the external source) 21 is provided on each end portion of a rear surface of the bottom plate 14a of the chassis 14 in the long-side direction. The inverter board 21 is provided with a circuit such as a transformer (not illustrated) that generates a high-frequency voltage as an electric drive power for the cold cathode fluorescent tube 17. The electric power is supplied from the circuit to each cold cathode fluorescent tube 17 through the relay connectors 19.

### 2. Description of Effects

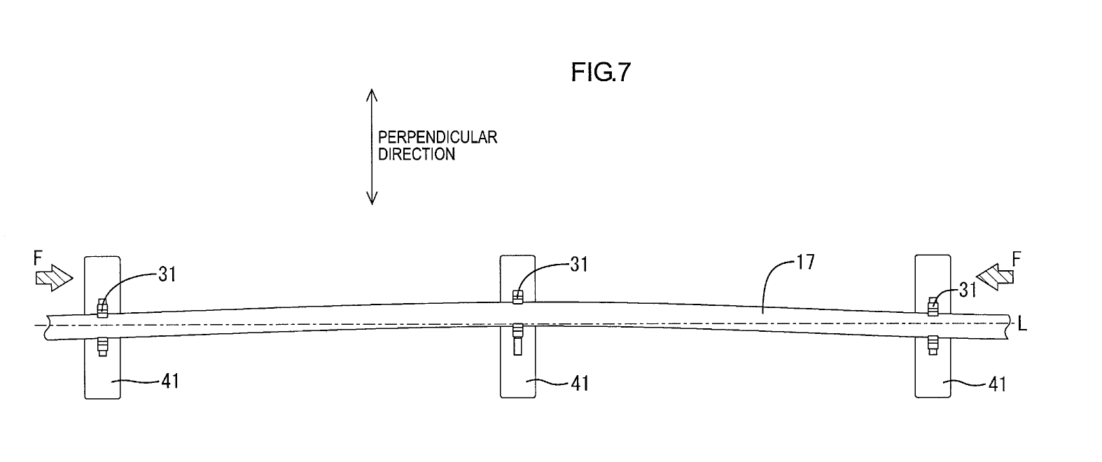

In the backlight unit 12 of the present embodiment, the gripping member 31 included in the retainer 30 can be displaced in the direction perpendicular to the axis L of the cold cathode fluorescent tube 17. With this configuration, the movement of the cold cathode fluorescent tube 17 in the vertical direction in FIG. 4 is restrained by the retainer 30. However, the cold cathode fluorescent tube 17 can be freely displaced (moved) in the direction perpendicular to the tube axis L (the horizontal direction in FIG. 4). Accordingly, if the chassis 14 is thermally contracted and the cold cathode fluorescent tube 17 is subjected to an axially inward force F, the cold cathode fluorescent tube 17 is deformed in a curved shape as illustrated in FIG. 7, and thus the force F can be released. Accordingly, the cold cathode fluorescent tube 17 is hardly or less likely to be broken or damaged. In FIG. 7, the middle one of the gripping members 31 is slid in the direction perpendicular to the tube axis L with the deformation of the cold cathode fluorescent tube 17.

In the present embodiment, the slide mechanism S1 provides the displacement mechanism that is configured to displace the gripping member 31. The slide mechanism S1 provides the cold cathode fluorescent tube 17 with high following capability with respect to the deformation, and thus failure will not occur.

In the present embodiment, the slide mechanism S1 is provided by the slide cutout 45 of the mounting member 41 and the column support 35 of the gripping member 31. However, the slide mechanism S1 is not limited to this configuration. The slide mechanism S1 may be provided by the housing portion 43 of the mounting member 41 and the base portion 33 of the gripping member 31. Specifically, the base portion 33 may be tightly fitted into the housing portion 43 such that the base portion 33 is slid along the housing portion 43. With this configuration, the base portion 33 and the housing portion 43 can function as the slide mechanism S1. In such a case, the column support 35 may be loosely fitted into the slide cutout 45.

### Second Embodiment

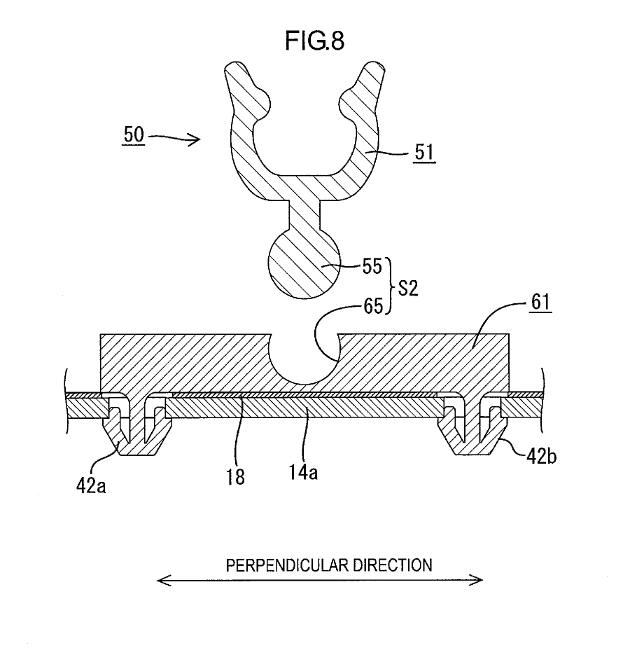

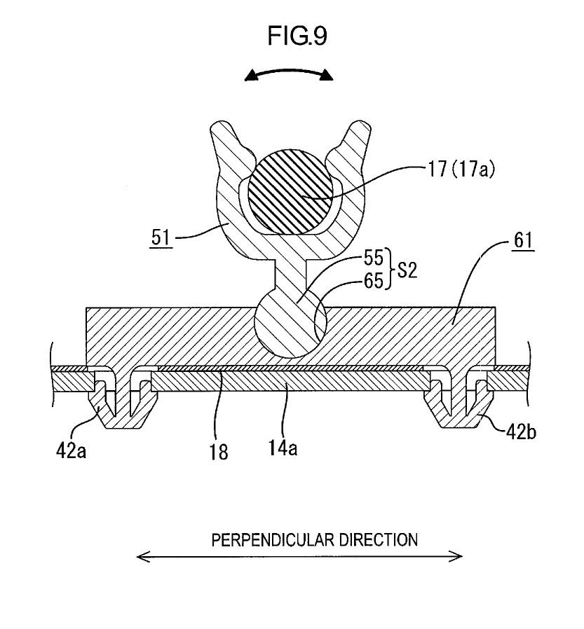

The second embodiment of the present invention will be described with reference to FIG. 8 and FIG. 9. In the second embodiment, the configuration of the retainer 30 is partially changed from that in the first embodiment. Since the other components are same as those in the first embodiment, the same components will be indicated by the same symbols as the first embodiment and will not be explained.

As illustrated in FIG. 8 and FIG. 9, a retainer 50 of the second embodiment includes a gripping member 51 gripping the cold cathode fluorescent tube 17 and a mounting member 61 mounting the gripping member 51 on the bottom plate 14a of the chassis 14. The gripping member 51 includes a curved protrusion 55 and the mounting member 61 includes a receiving portion (a curved recess) 65 on its upper surface. The gripping member 51 is fitted to the mounting member 61 by fitting the curved protrusion 55 into the receiving portion 65.

The curved protrusion 55 and the receiving portion 65 provide a ball joint mechanism S2 in which a curved surfaces are fitted with each other. The gripping member 51 can be tilted on the curved protrusion 55 in any directions of 360 degree. With this configuration, the cold cathode fluorescent tube 17 can be moved in the direction perpendicular to the tube axis L (the horizontal direction in FIG. 9), and thus the same effects as the first embodiment can be obtained. Specifically, if the chassis 14 is thermally contracted and the cold cathode fluorescent tube 17 is subjected to an axially inward force F, the cold cathode fluorescent tube 17 is deformed in a curved shape, and thus the force F can be released. Accordingly, the cold cathode fluorescent tube 17 is hardly or less likely to be broken or damaged.

### Third Embodiment

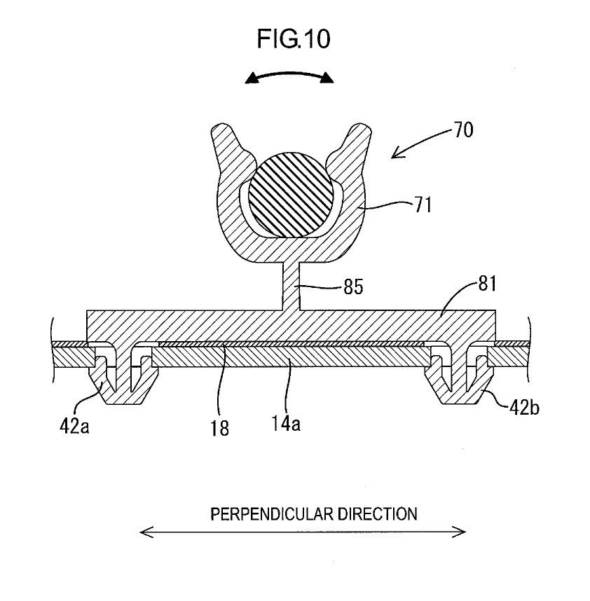

The third embodiment of the present invention will be described with reference to FIG. 10. In the third embodiment, the configuration of the retainer 30 is partially changed from that in the first embodiment. Since the other components are same as those in the first embodiment, the same components will be indicated by the same symbols as the first embodiment and will not be explained.

As illustrated in FIG. 10, a retainer 70 of the third embodiment includes a mounting portion 81 mounted to the bottom plate 14a of the chassis 14, a gripping portion 71 gripping the cold cathode fluorescent tube 17, and a connection wall 85 connecting the mounting portion 81 and the gripping portion 71. The mounting portion 81, the gripping portion 71, and the connection wall 85 are integrally made of a synthetic resin.

As illustrated in FIG. 10, the connection wall 85 has a plate-like shape having a small thickness, and thus the connection wall 85 can be deformed in the direction perpendicular to the axis L of the cold cathode fluorescent tube 17 (the horizontal direction in FIG. 10). Specifically, in this embodiment, the gripping portion 71 is displaced with respect to the mounting portion 81 in the direction perpendicular to the tube axis L by the deformation of the connection wall 85.

With this configuration, the movement of the cold cathode fluorescent tube 17, in the direction perpendicular to the axis L of the cold cathode fluorescent tube 17 (the horizontal direction in FIG. 10) is not restrained, and thus the same effects as the first embodiment can be obtained. Specifically, if the chassis 14 is thermally contracted and the cold cathode fluorescent tube 17 is subjected to the axially inward force F, the cold cathode fluorescent tube 17 is deformed in a curved shape, and thus the force F can be released. Accordingly, the cold cathode fluorescent tube 17 is hardly or less likely to be broken or damaged. In addition, since the retainer 70 is made of one component in the present embodiment, the number of components and the cost thereof do not increase.

### Fourth Embodiment

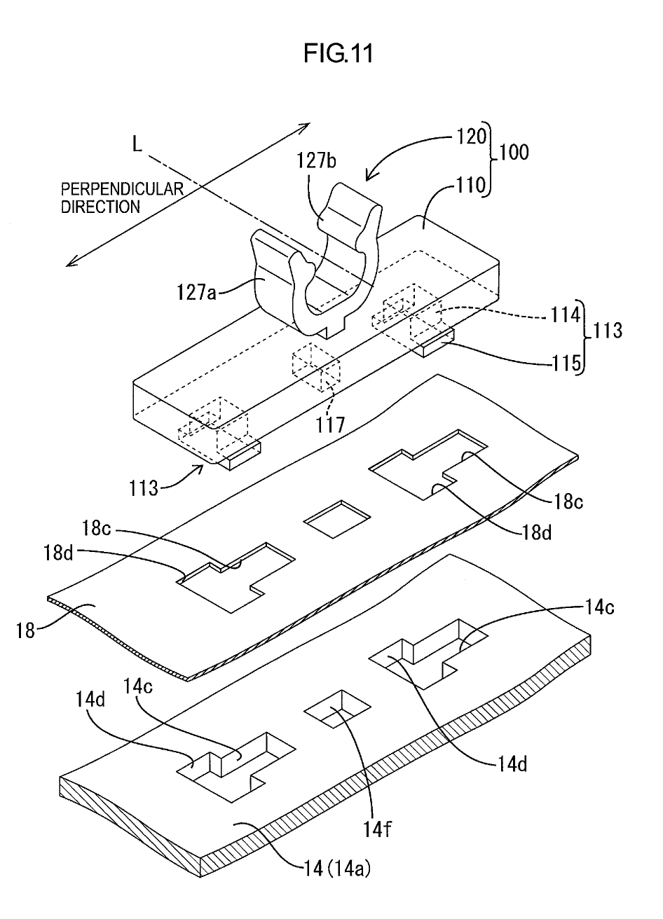

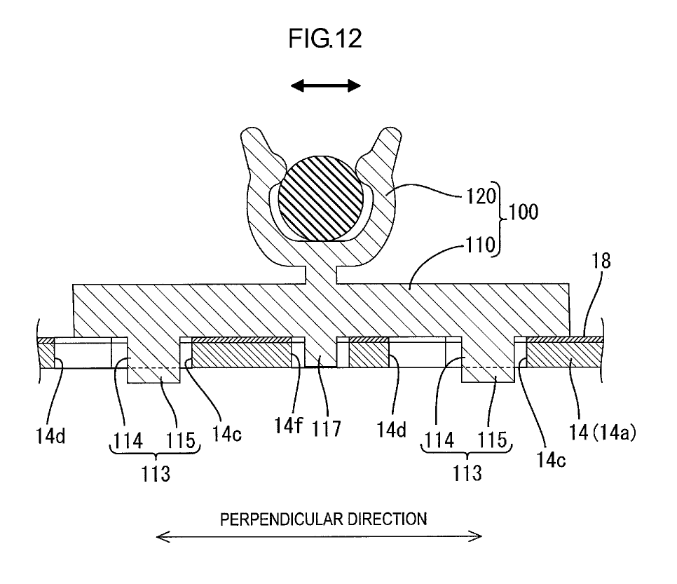

The fourth embodiment of the present invention will be described with reference to FIG. 11 and FIG. 12. In the fourth embodiment, the configuration of the retainer 30 is partially changed from that in the first embodiment. Since the other components are same as those in the first embodiment, the same components will be indicated by the same symbols and will not be explained.

As illustrated in FIG. 11, a retainer 100 of the fourth embodiment includes a mounting portion 110 and a gripping portion 120 gripping the cold cathode fluorescent tube 17.

The mounting portion 110 is made of a synthetic resin. The mounting portion 110 has an elongated plate shape in the direction perpendicular to the axis L of the cold cathode fluorescent tube 17.

The gripping portion 120 is integrally formed on an upper surface of the mounting portion 110. The gripping portion 120 has the same configuration as the gripping portion included in the retainer 30 of the first embodiment. The gripping portion 120 includes a pair of arm portions 127a, 127b. The gripping portion 120 has an open end ring overall shape opening toward the front side and holds the cold cathode fluorescent tube 17 from each side.

The mounting portion 110 is attached to the bottom plate 14a of the chassis 14 in a slidable manner in the direction perpendicular to the axis L of the cold cathode fluorescent tube 17. Specifically, a pair of slide cutouts 14c is formed in the bottom plate 14a of the chassis 14.

The slide cutouts 14c extend through the bottom plate 14a of the chassis 14. An axis of each slide cutout 14c extends in the direction perpendicular to the axis L of the cold cathode fluorescent tube 17. On an end of each slide cutout 14c (on a left end in FIG. 11), a mounting hole 14d is provided. The mounting hole 14d has a larger width than the slide cutout 14c.

On each end portion of a rear surface of the mounting portion 110, a slide leg 113 is provided. The slide legs 113 each have a substantially T-shape. When the retainer 100 is mounted to the slide cutout 14c through the mounting holes 14d, the stoppers 115 of the slide legs 113 are stopped by the rear surface of the bottom plate 14. Thus, the mounting portion 110 does not drop off from the bottom plate 14a of the chassis 14.

Further, the light reflection sheet 18 arranged on the upper surface of the bottom plate 14a of the chassis 14 includes holes 18c, 18d at positions corresponding to the slide cutouts 14c and the mounting holes 14d. The holes 18c, 18d each have a size same as or slightly larger than the slide cutout 14c and the mounting hole 14d such that the holes 18c, 18d do not contact with the slide legs 113.

The slide cutout 14c has a sufficient width to allow an axial portion 114 of the slide leg 113 to be smoothly slid. Thus, the retainer 100 including the mounting portion 110 can be slid along the slide cutout 14c in the direction substantially perpendicular to the axis L of the cold cathode fluorescent tube 17.

With this configuration, the movement of the cold cathode fluorescent tube 17 in the direction perpendicular to the axis L of the cold cathode fluorescent tube 17 is not restrained, and thus the same effects as the first embodiment can be obtained. Specifically, if the chassis 14 is thermally contracted and the cold cathode fluorescent tube 17 is subjected to an axially inward force F, the cold cathode fluorescent tube 17 is deformed in a curved shape, and thus the force F can be released. Accordingly, the cold cathode fluorescent tube 17 is hardly or less likely to be broken or damaged. In addition, in the present embodiment, the retainer 100 is composed of one component. Thus, the number of components and the cost thereof do not increase.

Since the slide mechanism provides the cold cathode fluorescent tube 17 with high following capability with respect to the deformation, a failure (for example, the gripping member is stuck in and does not move) hardly occur.

Additionally, a stopper cutout 14f is formed in the bottom plate 14a of the chassis 14 between the slide cutouts 14c. A stopper 117 provided on the rear surface of the mounting portion 110 is fitted into the stopper cutout 14f. The stopper cutout 14f and the stopper 17 are provided to prevent the retainer 100 from dropping off (from the chassis). Specifically, the stopper cutout 14f and the stopper 17 fitted with each other restrict the sliding amount of the stopper leg 113 such that the stopper leg 113 only moves in the slide cutout 14f and does not move to the mounting hole 14d.

### Fifth Embodiment

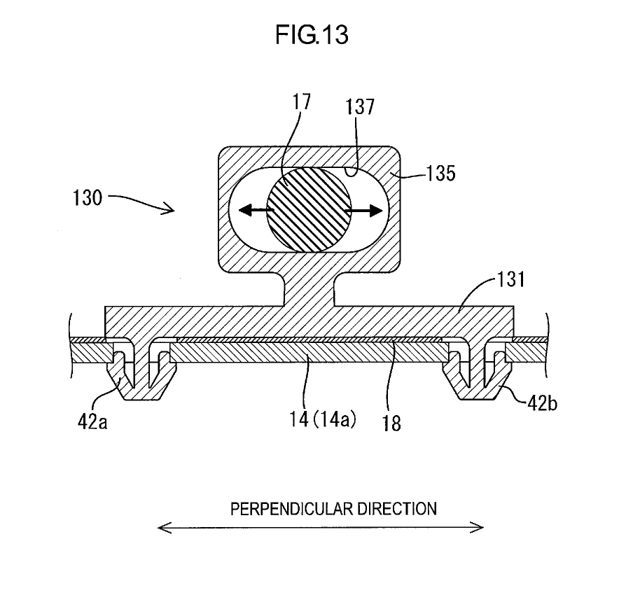

The fifth embodiment of the present invention will be described with reference to FIG. 13. In the fifth embodiment, the configuration of the retainer 30 is partially changed from that in the first embodiment. Since the other components are same as those in the first embodiment, the same components will be indicated by the same symbols as the first embodiment and will not be explained.

As illustrated in FIG. 13, a retainer 130 of the fifth embodiment includes a mounting portion 131 mounted on the bottom plate 14a of the chassis 14 and a frame 135 defining a cutout.

The mounting portion 131 is made of a synthetic resin. The mounting portion 131 has an elongated shape in the direction perpendicular to the axis L of the cold cathode fluorescent tube 17 (the horizontal direction in FIG. 13). The mounting member 41 includes an elastic stopper 42a, 42b at each end portion of the rear surface thereof. The elastic stoppers 42a, 42b are fitted in stopper holes 14g formed in the chassis 14 such that the mounting portion 131 is fixed to the bottom plate 14a of the chassis 14.

The frame 135 is located on an upper surface side of the mounting portion 131 and is integrally formed with the mounting portion 131. The frame 135 has a plate-like shape elongated in the direction perpendicular to the axis of the cold cathode fluorescent tube 17. The frame 135 includes a discharge tube insertion cutout 137 in the middle thereof. The cold cathode fluorescent tube 17 passes through the discharge tube insertion cutout 137. The discharge tube insertion cutout 137 has the width substantially the same as the diameter of the cold cathode fluorescent tube 17. The axis of the discharge tube insertion cutout 137 extends, i.e., the discharge tube insertion cutout 137 is elongated, in the direction perpendicular to the axis L of the cold cathode fluorescent tube (the horizontal direction in FIG. 13).

With this configuration, the movement of the cold cathode fluorescent tube 17 in the vertical direction in FIG. 13 is restrained by the discharge tube insertion cutout 137. However, the movement of the cold cathode fluorescent tube 17 in the direction perpendicular to the axis L of the cold cathode fluorescent tube 17 (the horizontal direction in FIG. 13) is not restrained. Accordingly, the same effects in the first embodiment can be obtained in the present embodiment. Specifically, if the chassis 14 is thermally contracted and the cold cathode fluorescent tube 17 is subjected to an axially inward force F, the cold cathode fluorescent tube 17 is deformed in a curved shape, and thus the force F can be released. Accordingly, the cold cathode fluorescent tube 17 is hardly or less likely to be broken or damaged. In addition, in the present embodiment, the retainer 70 is composed of one component. Thus, the number of components and the cost thereof do not increase.

### Other Embodiments

The present invention is not limited to the above embodiments described in the above description and the drawings. The following embodiments are also included in the technical scope of the present invention, for example.

(1) In the above first to fifth embodiments, the cold cathode fluorescent tube 17 is used as one example of the discharge tube. However, a hot cathode fluorescent tube may be used.

(2) In the first embodiment, the slide mechanism S1 includes the slide cutout 45, but the present invention is not limited to the slide cutout 45. For example, a guide rail may be provided to allow the gripping portion to be slid.

(3) In the above first to fifth embodiments, TFTs are used as switching components of the display device (the liquid crystal display device). However, the technology described above can be applied to liquid crystal display devices including switching components other than TFTs (e.g., thin film diode (TFD)). Further, the technology can be applied to not only color liquid crystal display devices but also black-and-white liquid crystal display devices.

(4) In the above first to fifth embodiments, the liquid crystal display device including the liquid crystal panel as a display panel is used. However, the technology can be applied to display devices including other types of display panels.

(5) In the above first to fifth embodiments, the television device including the tuner is used. However, the technology can be applied to a display device without the tuner.

### EXPLANATION OF SYMBOLS

10: display device, 11: liquid crystal panel, 12: backlight unit (lighting device), 14: chassis, 17: cold cathode fluorescent tube, 19: relay connector, 30, 50, 70, 100, 130: retainer, 31, 51: gripping member, 33; base portion, 35: column support, 41, 61: mounting member, 43: housing portion, 45: slide cutout, 55: curved protrusion, 65: receiving portion, 71, 120: gripping portion, 81, 110, 131: mounting portion, 85: connection wall, 135: frame defining a cutout, 137: discharge tube insertion cutout, S1: slide mechanism, S2: ball joint mechanism, TV: television device, L: tube axis

1. A lighting device comprising:
a discharge tube;
a chassis housing the discharge tube; and
a retainer holding the discharge tube such that the discharge tube is allowed to be displaced with respect to a bottom plate of the chassis in a direction perpendicular to an axis of the discharge tube.

2. The lighting device according to claim 1, wherein the retainer includes:
a gripping member gripping the discharge tube;
a mounting member mounting the gripping member on the bottom plate of the chassis; and
a displacement structure by which the gripping member and the mounting member are fitted with each other such that the gripping member is allowed to be displaced in the direction perpendicular to the axis of the discharge tube.

3. The lighting device according to claim 2, wherein the displacement structure is a slide structure by which the mounting member and the gripping member are fitted with each other such that the gripping member is allowed to be slid in the direction perpendicular to the axis of the discharge tube.

4. The lighting device according to claim 3, wherein the mounting member includes a cutout to which the gripping member is fitted such that the gripping member is allowed to be slid in the direction perpendicular to the axis of the discharge tube.

5. The lighting device according to claim 4, wherein
the gripping member includes a gripping portion gripping the discharge tube, a column support supporting the gripping portion, and a base portion, the column support being slidably fitted into the cutout, and
the mounting member includes a housing portion communicated with the cutout, the housing portion housing the base portion of the gripping member.

6. The lighting device according to claim 2, wherein the displacement structure is a ball joint structure by which the mounting member and the gripping member are fitted with each other at curved surfaces thereof.

7. The lighting device according to claim 1, wherein the retainer includes:
a gripping portion gripping the discharge tube;
a mounting portion mounted on the bottom plate of the chassis; and
a connection wall having a plate-like shape and connecting the mounting portion and the gripping portion, the connection wall being configured to be bent and displaced in the direction perpendicular to the axis of the discharge tube.

8. The lighting device according to claim 1, wherein the retainer includes:
a gripping portion gripping the discharge tube; and
a mounting portion mounted on the bottom plate of the chassis, the mounting portion being allowed to be slid in the direction perpendicular to the axis of the discharge tube.

9. The lighting device according to claim 1, wherein the retainer includes:
a frame having a discharge tube insertion cutout through which the discharge tube passes, the discharge tube insertion cutout having an elongated shape in the direction perpendicular to the axis of the discharge tube, whereby the discharge tube is allowed to be displaced within the discharge tube insertion cutout in the direction perpendicular to the axis of the discharge tube; and
a mounting portion mounted on the bottom plate of the chassis.

10. A display device comprising:
the lighting device according to claim 1; and
a display panel configured to provide display using light emitted from the lighting device.

11. The display device according to claim 10, wherein the display panel is a liquid crystal display including a pair of substrates with liquid crystals sealed therebetween.

12. A television device comprising the display device according to claim 10.
